(19) United States
(12) Patent Application Publication
(10) Pub. No.: US 2004/0211904 A1
(43) Pub. Date: Oct. 28, 2004

(54) Sheet detecting assembly and method

(76) Inventors: Barry Clifford Scowen, Surrey (GB); Peter Dilwyn Evans, Hants (GB); David Alan Brooks, Hants (GB)

Correspondence Address: Oliff & Berridge, PO Box 19928, Alexandria, VA, 22320, US

(21) Appl. No.: 10/472,600

(22) PCT Filed: Mar. 18, 2002
(86) PCT No.: PCT/GB02/01236

(30) Foreign Application Priority Data
Mar. 19, 2001 (GB) 0106816.2

(51) Int. Cl. G01J 5/02; G01N 21/86

(52) U.S. Cl. 250/341.1; 250/372; 250/559.36

(57) ABSTRACT

A sheet detecting assembly for use in detecting sheets passing along a transport path. The assembly comprises a linear array (15-17) of radiation emitters extending transverse to the transport path. At least one first radiation emitter (29A) at an end of the array is physically oriented so as to generate a radiation beam centred a line which crosses the transport path at a non-orthogonal angle, and at least one second emitter (29A) is physically oriented so as to generate a radiation beam centred on a respective line substantially orthogonal to the transport path; and a detector system for detecting the radiation after it has impinged on a sheet.

The invention relates to a sheet detecting assembly and method.

In the field of banknote and other security document handling apparatus, a number of sophisticated techniques and apparatus have been developed to enable denomination, in the case of banknotes, and authenticity to be determined. Such apparatus varies between large scale banknote sorters and the like which are typically used in central bank locations, and much smaller, desktop devices. An example of a desktop device is the De La Rue 2600 series in which banknotes are fed from a single input hopper past a sensor suite to an output hopper. Depending upon the sensors provided, the counter can determine information about the banknotes as they are counted and generate suitable flags or even cease operation in some cases.

In order to achieve a compact arrangement, the sensing equipment such as radiation emitters and detectors, need to be located close to the transport path but there is a problem that rollers and the like used to define the transport path make it difficult to scan some parts of the document.

WO-A-97/31340 discloses a system for generating an angled light beam but this makes use of a complex lens arrangement which is expensive and undesirable.

DE19820057 describes the use of an array of LEDs for causing light to impinge on a banknote at a non-orthogonal angle.

In accordance with a first aspect of the present invention, a linear array of radiation emitters extending transverse to the transport path, at least one first radiation emitter at an end of the array being physically oriented so as to generate a radiation beam centred on a line which crosses the transport path at a non-orthogonal angle, and at least one second emitter being physically oriented so as to generate a radiation beam centred on a respective line substantially orthogonal to the transport path; and a detector system for detecting the radiation after it has impinged on a sheet.

In this aspect of the invention, we increase the area of a document which can be scanned by generating at least one angled radiation beam which can then be directed towards part of a security document which is close or abuts a feed roller.

In contrast to the arrangement of WO-A-97/31340, the present invention avoids the use of lenses and the like while achieving an optimum arrangement by the use of orthogonally oriented emitters for the majority of the array and angled emitters at the end or ends of the array.

Conveniently, at least those emitters not including the angled emitter are associated with a collimating system (although in some cases the emitters themselves could generate collimated beams). The collimating system may be in the form of a housing having a number of bores into each of which a respective emitter is located.

The radiation beams can generate radiation in any convenient wavelength range including the visible, ultraviolet or infra-red although the latter is preferred in this particular case.

Also, the detector system may detect radiation which has been transmitted across the transport path and thus through a sheet or has been reflected by a sheet.

Each emitter may be associated with a respective detector such as a photodiode but for convenience, a set of emitters may be associated with a single photodiode. Lateral resolution is achieved by selective energization of the emitters. Alternatively, a single emitter could be used with an array of detectors. Thus, in accordance with a second aspect of the present invention, a sheet detecting assembly for use in detecting sheets passing along a transport path, comprises one or more radiation emitters for generating radiation which crosses the transport path; and a linear array of radiation detectors extending transverse to the transport path, at least one first radiation detector at an end of the array being arranged (typically physically oriented) to detect radiation centred on a line which crosses the transport path at a non-orthogonal angle after it has impinged on a sheet.

In a similar way to the first aspect, preferably each detector other than said at least one first detector detects radiation centred on a respective line substantially orthogonal to the transport path in use.

In the case of banknotes, it is often the case that the denomination of a banknote can be determined by detecting its size. This must often be done as the banknote is being transported along the transport path and in order to maintain highspeed processing (for example 20 notes per second or more) the calculation of note size must be carried out very quickly. This can be a problem if, as is often the case, a note is transported at an angle (the skew angle) to the transport direction. In that situation, it is necessary to compensate for the skew angle in order to determine the “length” of the banknote in the general transport direction.

Thus, we provide apparatus for determining the dimension (h) of a rectangular sheet orthogonal to a leading edge of the sheet as it is fed along a transport path comprises a pair of sheet edge detectors spaced apart by distance (d) along a line substantially orthogonal to the transport direction; a processor connected to the detectors for monitoring output signals from the detectors corresponding to the passage of the sheet and for computing the said dimension (h) in the accordance with formula:

$$h = T * f ( t , d ) \\ where f ( t , d ) = 1 / {\sqrt{( ( t}}^{2} / {d}^{2} ) + 1 )$$

T is the measured sheet dimension in the transport direction, and

t is the distance travelled by the sheet in the transport direction between the detection of the sheet edge by each detector;

and a look-up table addressed by the processor and storing a value of f (t,d) for each value of t.

This enables a computation to be made very quickly by reducing the computation to a simple look-up operation. It is therefore not necessary to calculate the skew angle on the fly as a sheet is being fed.

It is also often necessary to determine the location of an edge of a sheet in a direction transverse to the transport direction, again for the purposes of determining note size. U.S. Pat. No. 4,559,451 discloses a system for determining the location of a document by reference to the intensity of light received by a detector. The intensity is compared with three or more predetermined threshold values and this is used to determine the position of the edge of a document relative to the detector. This only provides a relatively coarse determination unless a large number of thresholds are used and is not suitable in certain cases where very accurate determination of the location of a note is required.

In accordance with a third aspect of the present invention, a method of determining the location of an edge of a sheet comprises exposing the sheet to a linear array of radiation beams from respective sources; determining an approximate location of an edge of the sheet extending generally in a direction transverse to the linear array of radiation beams by determining which radiation beam is the first in the array to be at least partially intercepted by the sheet; using the detected intensity of said radiation beam to obtain from a look-up table an offset value corresponding to an amount by which the sheet partially overlaps said radiation beam; and modifying the previously determined approximate location by said offset value, and is characterized in that the look-up table stores values defining a curve relating the offset values with corresponding intensities, the or each curve being in the form of a multi-piecewise linear function.

In contrast to the prior art mentioned above, the present invention uses a set of linear functions to describe a non-linear obscuration pattern with a continuous distribution. It does not require the setting of threshold points and thus achieves much greater accuracy.

This aspect of the invention could be applied to a stationary sheet but is particularly useful where the sheet is being transported, the edge to be located extending in a direction generally parallel with the transport direction.

The stored curve may be common to all or some of the radiation sources but preferably the look-up table stores is a curve for each radiation source.

The curve can be stored at a variety of resolutions but for convenience of calculation speed and efficiency, we have found that a 3-piecewise linear function is suitable.

The third aspect of the invention can be used to locate opposite edges of a sheet so as to determine the lateral dimension between the edges. This may be modified to take account of skew feed.

The lateral dimension is typically determined by determining the distance between intercepts, on an x-axis parallel with the linear array of radiation beams, of lines parallel with the located edges and passing through the determined locations of the edges.

The invention is particularly suited to banknote handling equipment such as counters, sorters, dispensers, recirculators and the like but in most cases could also be applied to any equipment for handling sheets, typically rectangularly shaped sheets or continuous sheeting on web machines as will be readily apparent to a person skilled in the art.

An example of sheet handling apparatus and methods according to the present invention will now be described with reference to the accompanying drawings, in which:

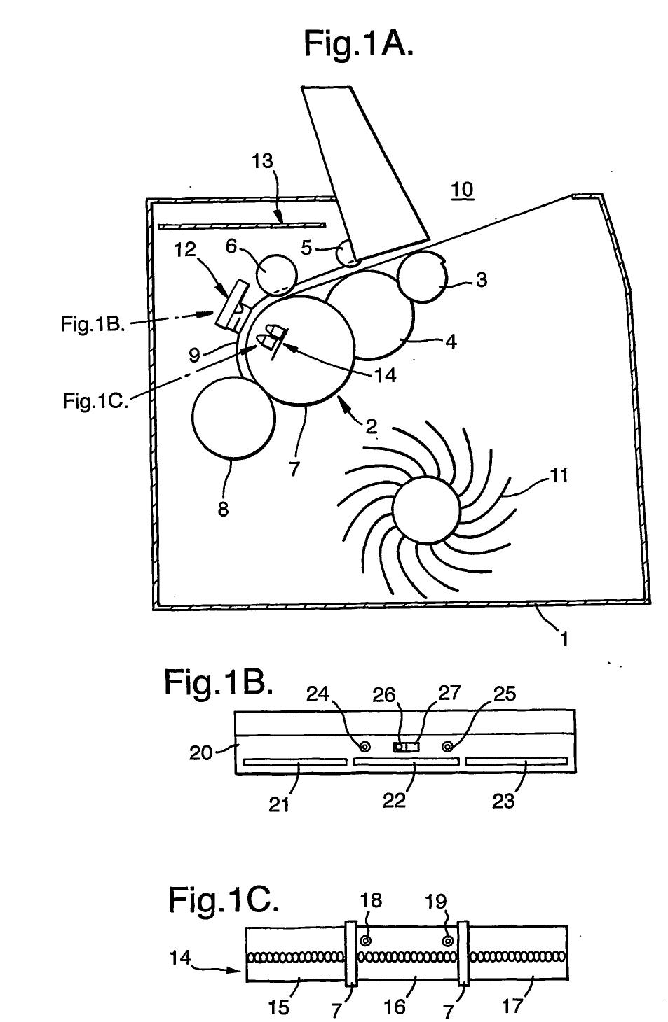

FIG. 1A is a schematic view of the apparatus with parts of the detector and emitter modules shown in more detail in FIGS. 1B and 1C respectively;

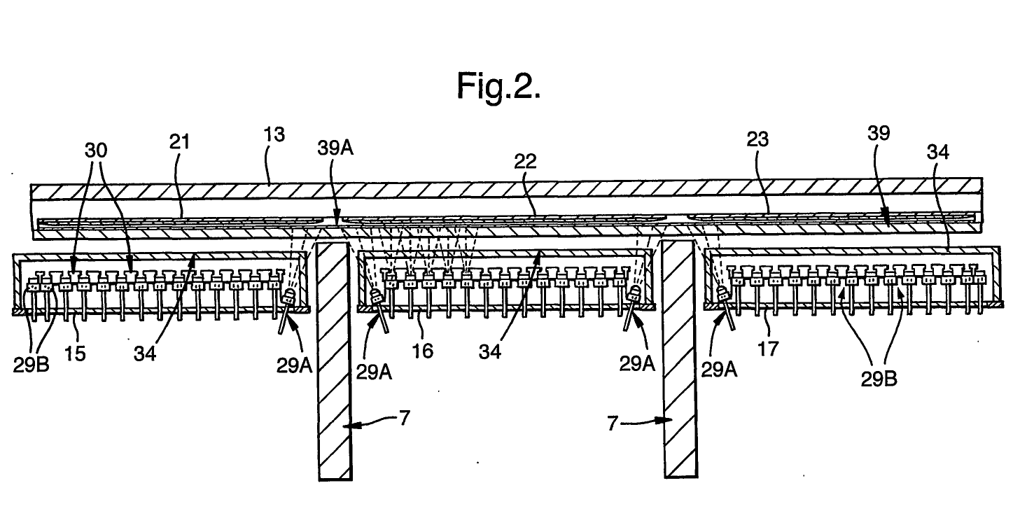

FIG. 2 illustrates the IR detector in more detail;

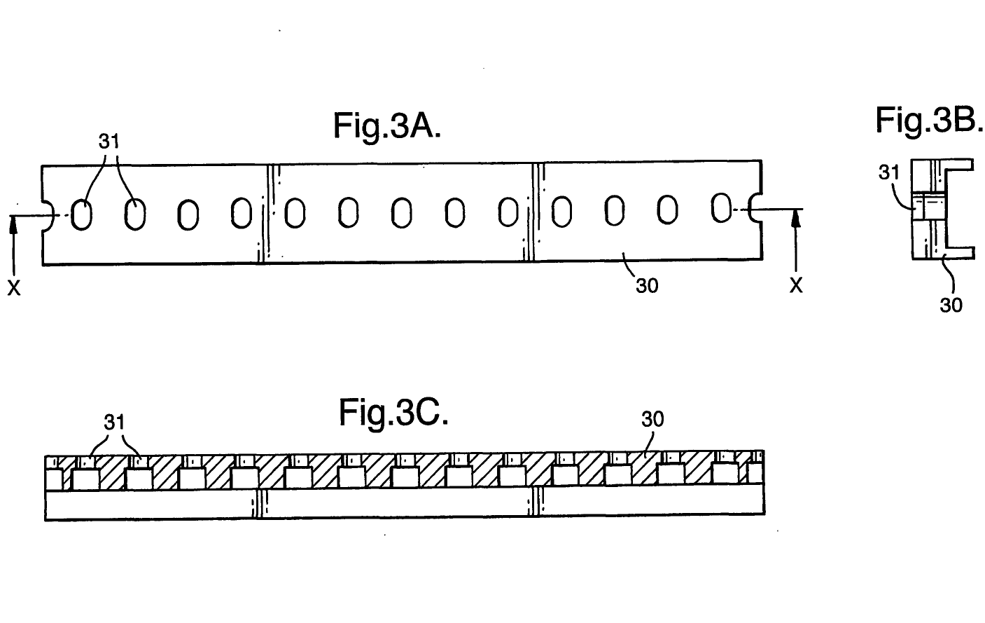

FIG. 3 illustrates the LED mounting and collimator in plan and section;

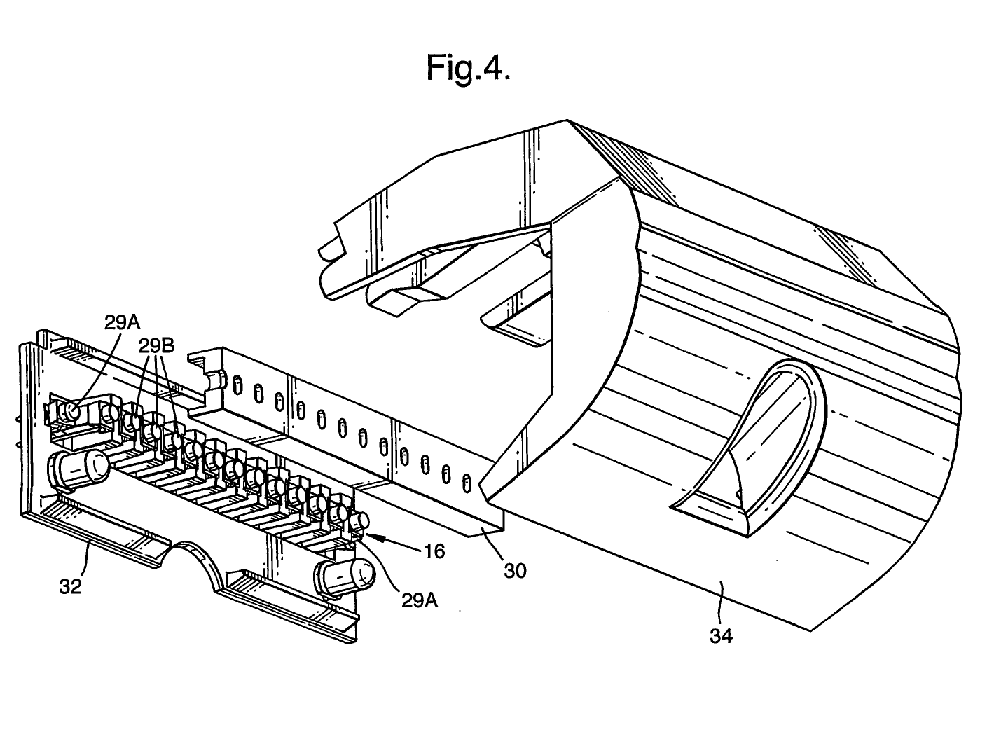

FIG. 4 illustrates in exploded form the primary components of the IR emitter;

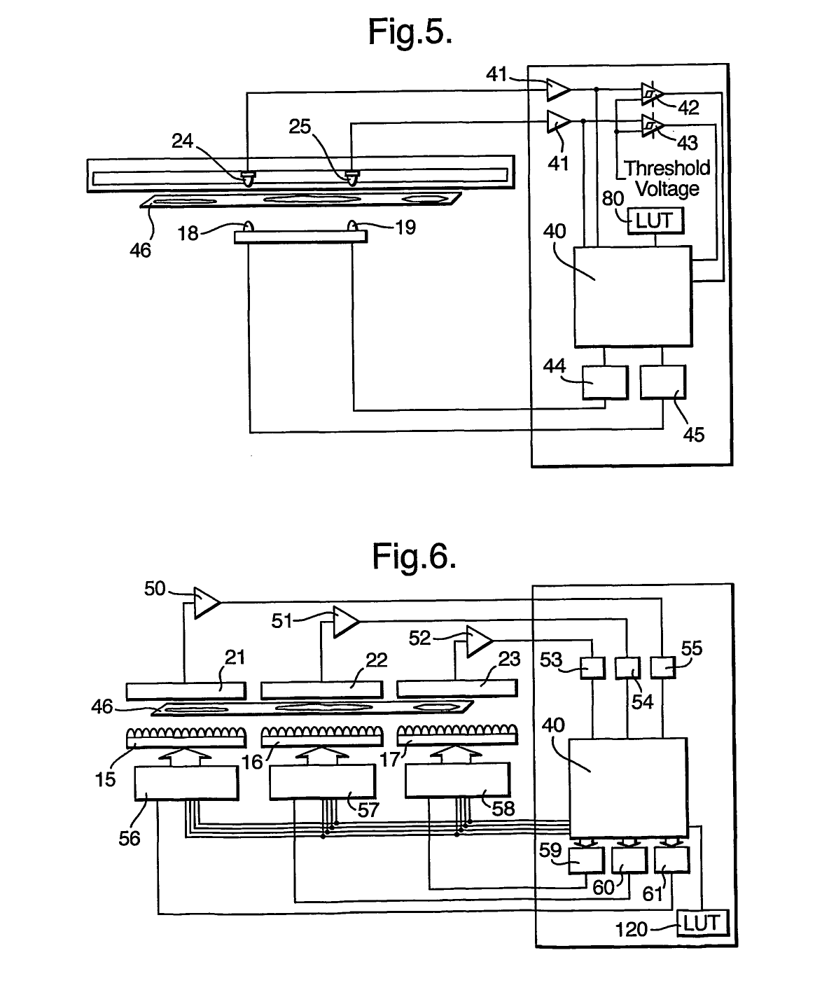

FIGS. 5-7 are block circuit diagrams illustrating the circuitry for the SD, IR/3D, and UV detector systems respectively;

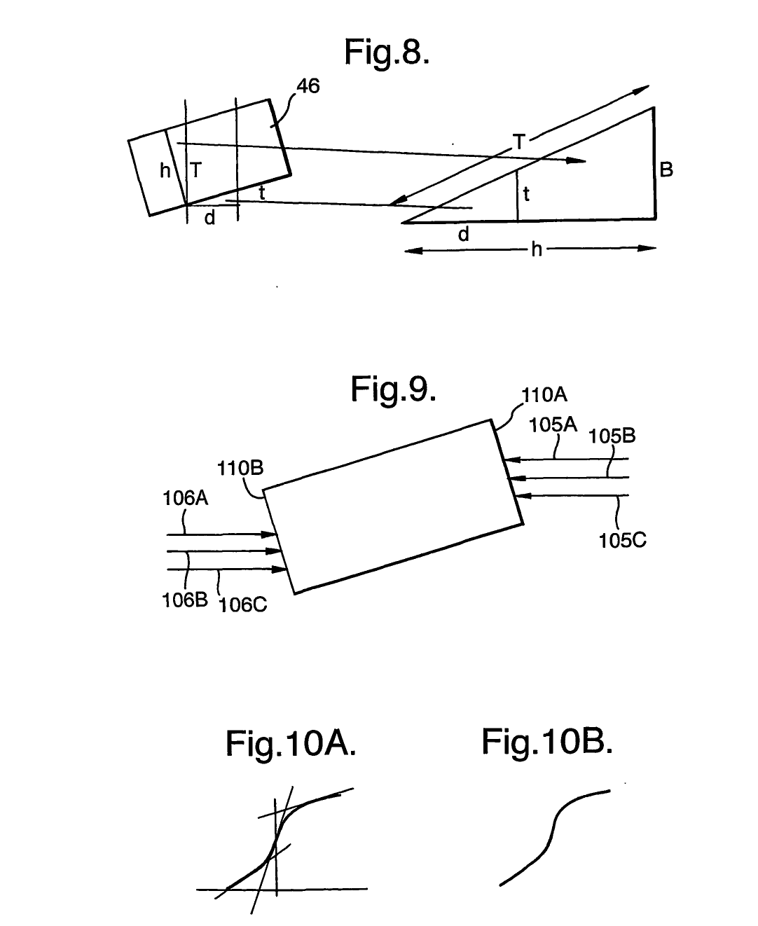

FIG. 8 is a diagram illustrating the SD processing;

FIG. 9 illustrates a skew fed note;

FIGS. 10A and 10B illustrate respectively an approximation and an original curve relating detected intensity to sheet overlap;

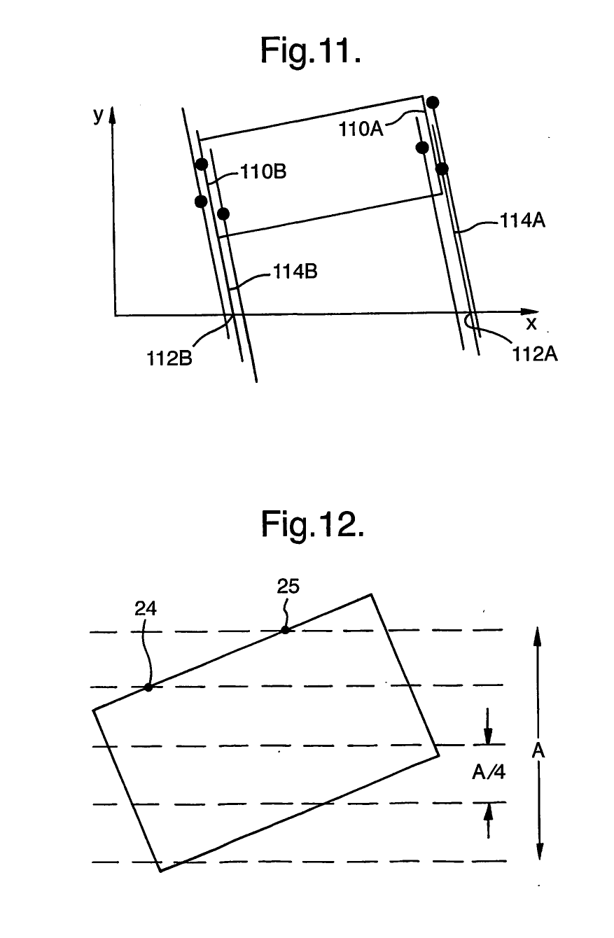

FIG. 11 illustrates the mathematical process for determining the lateral dimension of a note; and,

FIG. 12 illustrates the manner in which the note area is sub-divided.

The bank note counter shown in FIG. 1A is based on the De La Rue 2600 machine and is thus only illustrated schematically. The machine comprises a housing 1 in which is mounted a transport system 2 comprising a sequence of rotatably mounted rollers 3-8 which cooperate with each other and with a guide plate 9 to guide single bank notes stripped from the base of a stack in an input hopper 10 to a stacking wheel 11. During their passage along the transport path, the bank notes are guided past a sheet detecting assembly 12 coupled to a PCB 13 which carries a microprocessor (not shown).

As can be seen in FIG. 1C, the detecting assembly 12 comprises a first head 14 which incorporates three linear arrays or banks 15-17 of IR LEDs interleaved with rubber doubles detect rollers 7 together with a pair of orange SD (size detector) LEDs 18,19 mounted between the doubles detect rollers 7.

A second head 20 (FIG. 1B) is mounted on the opposite side of the transport path to the head 14 and includes 3 strip photodiodes 21-23, each coated with an IR transmissive filter material, and aligned with respective arrays 15-17; a pair of SD photo transistors 24,25 mounted behind orange filters and aligned with the LEDs 18,19 respectively; and a UV LED source 26 mounted adjacent a UV photodetector 27 located behind a blue band pass filter for detecting fluorescent light emitted by the bank note in response to UV irradiation.

The two pairs of SD emitters and detectors 18,24;19,25 are mounted facing one another across the note transport. The LEDs emit orange light of around 590 nm. The light falling on the opposing detectors passes through a pair of optical filters (1 mm of BG38 and 1 mm of OG750), which together create a band pass filter around the emitted wavelength of the LED. This arrangement limits IR cross talk from the 3D/IR feature detector and the UV and visible blue/green fluorescence from the UV bright detector 26,27.

The full width IR detection system consists of three wide photodiode strips 21-23 (FIG. 2) which are arranged in line across the note path creating three detection banks. (Each of the three photodiodes is actually made up of three separate photodiode chips wired in parallel, effectively acting as a single larger photodiode chip). These detectors are illuminated from the opposite side of the note transport path by the three banks of IR LEDs 15-17. Each bank 15-17 contains 15 LEDs 29A,29B (peak emission 850 to 875 nm). The end LEDs 29A of each bank that are next to the doubles detect rollers 7 are physically angled such that illumination is achieved right up to the edge of the rollers while the remaining LEDs 29B generate beams substantially orthogonal to the note path. When a note is present, the light will be scattered on to a larger area of the detector. The note will diffuse the beam across a potentially wider area than the beam alone. The photodiode chips in the detector head 20 are coated with an IR transparent, visible blocking resin to reduce the effects of the SD and UV bright detectors as well as the effects of ambient lighting.

An example of the resin collimators mounting the array 16 is shown in more detail in FIGS. 3 and 4. As shown in FIG. 4, the mounting arrangement includes a base 32 supporting the linear array of LEDs 16. As can be seen in FIG. 4, the majority of the LEDs 29B in the array 16 is mounted substantially parallel with each other while the LEDs 29A at each end are angled with respect to the LEDs 29B.

Each of the LEDs 29A,29B generates a wide angle infrared beam and the beams from LEDs 29B are collimated by means of a collimating element 30 which sits on the linear array 16. This collimating element 30 (shown in more detail in FIG. 3) is a plastics molding having a set of bores 31 into each of which a respective LED 29B is inserted in use. As can be seen in FIG. 2 the bores 31 serve to collimate the beam emitted by the LEDs 29B. The LEDs 29A do not have a collimator but the lensing of these devices produces a narrow beam.

After the collimator 30 has been assembled on the linear array 16, the components are covered by a transparent plastic housing 34.

The head 20 includes a glass window 39 behind which the photodiodes 21-23 are located. A light control film 39A is mounted on the window 39 and defines a louvre or venetian blind feature which restricts the entrance of ambient light which may get into the vicinity of the detector and affect the levels of light measured from a note.

Scan lines are acquired by sequentially illuminating each LED 29A,29B in each bank 15-17 and measuring the intensity of light arriving at the corresponding photodiode 21-23 to give 15 pixel measurements across each bank. Therefore the shape and size of each pixel in a scan line is determined by the beam pattern and intensity profile from each LED which falls onto its opposing photodiode. The position and beam pattern of each LED is controlled, particularly for precise note length determination, by using wide angled emission LEDs 29A,29B in conjunction with the beam collimator/alignment assembly 30 mounted over the top of each LED array. The apertures 31 in the collimator 30 are carefully manufactured to achieve the desired beam pattern while still achieving a low cost assembly.

The UV bright detector consists of the optically filtered LED UV source 26 illuminating a central region of the note as it moves past the detection head, together with the large area optically filtered photodiode 27 which is directed to view the same illuminated region of the note. The filtering over the UV LED (2.5 mm of Hoya U 360 glass) is designed to block any visible emission from the LED 26 allowing only UV radiation to fall onto the note surface. The filtering over the photodiode 27 (1 mm of Schott GG 420, 2 mm of Schott BG 39 and 2 mm of Schott BG 4) serves to block any UV radiation reflected or scattered from the surface of the note, allowing only visible blue fluorescence light from a note to pass. The strong IR block characteristic of this filter set also ensures that a negligible quantity of IR illumination from the 3D/IR feature emitters falls onto the photodiode. It will be noted in FIG. 2 that there is some overlap between the beams emitted by each of the LEDs 29B to provide continuity of long edge measurement from one LED to the next.

In order to process the signals received by each detector, a microprocessor 40 is provided on the PCB 13. As shown in FIG. 5, each of the phototransistors 24,25 is coupled via respective buffer amplifiers 41 directly to analogue to digital inputs of the microprocessor 40 and via respective comparators 42,43 to the microprocessor. Each comparator 42,43 also receives a threshold voltage as an input. A current to each LED 18,19, and thus their illumination intensities, is controlled by two pulse width modulation outputs 44,45 from the microprocessor 40.

The infrared detector system is shown in FIG. 6 where it will be seen that each photodiode 21-23 is contacted via a respective detector amplifier 50-52 to respective sample and hold circuits 53-55 which in turn are contacted to analogue to digital inputs of the microprocessor 40. Each LED array 15-17 is driven by a respective driver 56-58 by the microprocessor 40 which also supplies power to the drivers via respective controllers 59-61.

The operation of a single bank 15-17 will be initially described. The IR emitters of a single bank can be selected one at a time by the LED drive de-multiplexer circuitry 56-58 controlled by the LED selection lines from the processor 40. Once an LED is selected, its drive current and thus its intensity can be set using the LED power control circuitry 59-61 on the detector processor controller board.

The signal from the corresponding large area photodiode 21-23 is amplified and buffered within the combined detector assembly. The signal is then sent to the sample and hold circuitry 53-55 on the detector processor board from where the sampled signals are digitised by the analogue to digital (A to D) converter built into the microprocessor 40.

With no note 46 in the transport, the processor 40 can set the power of each individual LED within a bank such that a signal of around 90% of the full scale range of the A to D converter is measured. The particular drive setting for each of the LEDs is recorded and this will be the drive level used each time this LED is selected.

The process of scanning a line involves sequentially selecting each LED 29A, 29B and simultaneously setting its particular drive level. This process is performed for each of the fifteen LEDs within a bank. A complete transport width scan sets the first LEDs of all three banks 15-17, each with their own drive level. At this point all three sample and holds 53-55 are set to hold the detected signals. Now the second LED in each bank can be illuminated with their three individual drive levels. In the background, the A to D converter will be digitising the three previous held signal levels. This process is repeated fifteen times to complete a single full width scan.

Note scans are initiated on the detection of a note in the transport by the SD detectors 24,25. Each complete full width scan is synchronised with the machine transport clock (a clock signal which is locked to the movement of the mechanical note transport) to allow the creation of two dimensional note image scans.

The emitter 26 and detector 27 of the UV bright detector are both mounted on the combined detector assembly and therefore view only one surface of the note. The current to the UV LED, and thus its intensity, is controlled by a Pulse Width Modulation output circuit 70 from the processor 40 on the detection processor board.

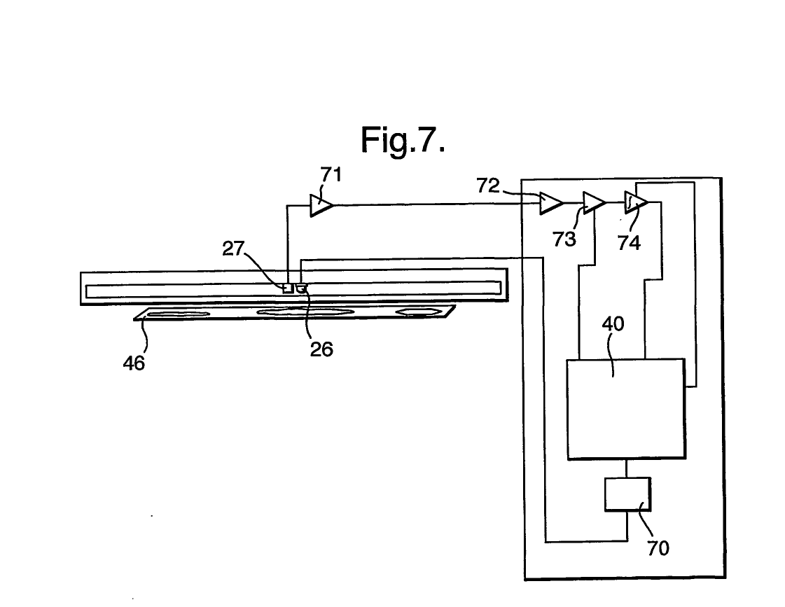

The LED 26 illuminates a region in the centre of the note 46 with UV, causing any fluorescent pigments to re-emit their characteristic fluorescence to the detector 27 in its overlapping field of view. The signal from the photodiode is then amplified 71 (FIG. 7) on the combined detector board and passed to the detector processor board. On the detector processor board the signal is buffered through a low pass filter 72, before being passed to a variable gain amplifier 73. The signal is then passed to a switched integrator 74, the output of which is sent to one of the processor's A to D inputs.

A measurement cycle involves two distinct stages. A dark calibration stage which makes a measure of any signal offsets caused by the detection circuitry or ambient light within the detected field, and the measurement stage which actually measures the UV bright level (on top of any signal offsets).

Firstly the gain of the variable gain amplifier 73 is set to the predefined operating level. For a dark calibration measurement, the LED 26 is not switched on. The switched integrator 74 is opened for a set integration time. At the end of this integration time the integrated “dark” level is measured by the processor 40. A measurement cycle involves the same duration integration cycle but this time the UV LED 26 is turned on to its predefined drive level. The integrated “signal” level is again measured by the processor 40. The UV bright level is calculated by subtracting the “dark” level from the “signal” level.

Two “predefined” levels were described in the above measurement—the variable gain amplifier level and the UV LED drive level. These levels are determined in a manual calibration process by making the above UV bright measurement on a test card which has a known level of UV bright fluorescence. The particular UV bright level for the test card is manually entered into the processor. The processor 40 then performs a series of test runs, adjusting the variable gain and LED drive level until the defined UV bright level is matched. The particular gain and LED drive levels which are arrived at become the “predefined” levels and are written into non-volatile memory, completing the calibration process.

The detector 18,24,19,25 can be used to determine the dimension of each banknote orthogonal to its leading edge which is often useful for denomination determination and the like. This is carried out by the microprocessor 40 which is coupled with a look-up table 80.

As the sheet passes along the transport path, it will obscure the radiation emitted by each LED 18,19 from the corresponding photo transistor 24,25. The time at which this obscuring starts and the time at which it finishes is noted for each pair by the microprocessor 40. Given knowledge of the speed of the transport system, the microprocessor 40 can then compute a distance “t” corresponding to the distance travelled by the banknote 46 between the point at which the leading edge was detected by each photo transistor 24,25. This is illustrated in FIG. 8.

By similar triangles:

$$\frac{t}{d} = \frac{B}{h} \qquad ( 1 )$$

Using Pythagoras' Theorem:

B=\sqrt{T²−h²} (2)

Manipulating (1) and (2) into the form h=T*f(t,d):

$$f ( t , d ) = \frac{1}{\sqrt{\frac{{t}^{2}}{{d}^{2}} + 1}} \qquad ( 3 )$$

where:

T—measured short edge size

h—actual short edge size

t—distance between leading edge SD trigger points

d—gap between sensors 24,25

Computing the trigonometric ratios between the triangles, an estimate for true note length can be found based on gradient and a set of correction factors. To reduce the level of computation required, the correction factors, f are stored in a look up table (LUT) which is generated on powerup. Using the table, the actual short edge measure can be determined.

Long edge processing is controlled by a state machine which splits the necessary tasks into smaller chunks so as not to prevent the microprocessor 40 from servicing other tasks e.g. communications and UV detection. The first stage is to determine which areas of the note are to be used for the calculation. The note image is divided into four equal height horizontal parts (FIG. 12) with heights A/4 and the upper and lower boundaries between the horizontal segments are chosen as candidate search regions. The boundaries are determined by the SD detectors 24,25. These candidate positions are therefore placed approximately halfway vertically either side of the note image centre. The aim of using these regions is to allow the system to stay away from the note corners which may or may not be damaged when determining the long edge size. The system scans along these lines from extreme left and extreme right until the note edge is located. Now, since for a skewed note, two corners may lie close to these scan lines, the system uses the skew measurement provided by the SD sensors 24,25 to determine which line should be used for which scan. Examples of how the scan lines are used is shown below.

The long edge scheme effectively scans along these lines 105A-C, 106A-C (FIG. 9) and two neighbours using the i.r. LEDs and photodetectors 15-17, 21-23 until an edge 110A,110B is reached and the processor 40 then calculates the x intercept 112A,112B of a line 114A, 114B parallel to the short edge in each case (FIG. 11). The note length is then estimated from the difference between these intercepts. From this, there needs to be a suitable scheme for determining the location of the note edge. This is a two stage process: first step is to locate the approximate position of the edge and then refine the measurement based on data local to that edge. The first step is achieved by determining the first LED 29A,29B from either detector extreme (far left and right) that drops below a target band. This band relies on the target unobstructed LED levels obtained during calibration and is updated before every bundle is fed. This produces a repeated level which is stable over large numbers of note runs. The chosen LED position is then stored for the next stage which refines the edge position since the resolution of the IR sensor is low (effectively 4 by 4.3 mm). In order to satisfy the specified long edge accuracy of +/−2 mm per note, interpolation is required. The scheme employed is to use a look up table 120 of scaled values of a general illumination-edge curve. During development, a set of illumination profiles for each LED were recorded (FIG. 10B). From this, a general curve was generated which has been modelled as a 3-piecewise linear function (FIG. 10A). This function translates the scaled intensity received for the chosen LED directly into a sub-millimetric offset that needs to be added to the coarse LED position. The function is calculated during factory calibration and is stored in NOVRAM as a look up table. This speeds up the offset calculation since the values are already available and simply need to be scaled and chosen from the table.

Since the shape of the curve depends on the opacity of the note, an estimate of note intensity is made depending on how close the intensity at the candidate point is to a pre-determined mid level. If it is higher or lower then the note estimate is taken as the intensity of the third or second pixel towards the centre from the candidate point respectively. Although the pixel pitch is 3.64 mm, the LUT extends to 7.2 mm due to the illumination cone spread.

Using the offset, the location in sub-millimetre units, of candidate edge points to an origin can be calculated. The next stage is to determine the x-intercepts 112A,112B for each of these points. This is achieved using the formula (x+y*m) where x and y is the location of the point and m is the gradient (t/d) of the note as reported by the SD sensors (see above).

The average intercept position for both left and right edges (cl and cr) is calculated and the distance between them is calculated. From this, the actual note length can be calculated by

$$\frac{( cr - cl )}{\sqrt{1 + {m}^{2}}}$$

Since the square root function takes a substantial amount of processing time, the denominator is coded in the LUT 120 with m as the index.

The final length measure is reported to the main controller in 0.1 mm resolution.

The infra-red arrays 15-17,21,23 can also be used for authentication purposes by obtaining details of the response of the banknote to infra-red radiation in one or more areas so as to define an infra-red “pattern” which can then be compared with predetermined, authentic patterns.

1. A sheet detecting assembly for use in detecting sheets passing along a transport path, the assembly comprising a linear array of radiation emitters extending transverse to the transport path, at least one first radiation emitter at an end of the array being physically oriented so as to generate a radiation beam centred on a line which crosses the transport path at a non-orthogonal angle, and at least one second emitter being physically oriented so as to generate a radiation beam centred on a respective line substantially orthogonal to the transport path; and a detector system for detecting the radiation after it has impinged on a sheet.

2. An assembly according to claim 1, wherein the linear array has a first emitter at one end, the remainder being second emitters.

3. An assembly according to claim 1 or claim 2, wherein the emitters other than said at least one first emitter generate radiation beams which overlap on the transport path.

4. An assembly according to any of the preceding claims, wherein the radiation beam of said at least one first emitter is centred on a line which extends away from an adjacent emitter radiation beam.

5. An assembly according to any of the preceding claims, further comprising a collimating system for collimating radiation emitted by at least those radiation emitters(s) other than the said at least one first radiation emitter.

6. An assembly according to claim 5, wherein the collimating system is provided by a housing having a number of bores into each of which a respective emitter is located.

7. An assembly according to any of the preceding claims, wherein the detector system comprises a single detector such as a photodiode for detecting radiation emitted by a plurality of the radiation emitters.

8. A sheet detecting assembly for use in detecting sheets passing along a transport path, the assembly comprising one or more radiation emitters for generating radiation which crosses the transport path; and a linear array of radiation detectors extending transverse to the transport path, at least one first radiation detector at an end of the array being arranged to detect radiation centred on a line which crosses the transport path at a non-orthogonal angle after it has impinged on a sheet.

9. An assembly according to claim 8, wherein each detector other than said at least one first detector detects radiation centred on a respective line substantially orthogonal to the transport path in use.

10. An assembly according to any of the preceding claims, wherein the or each emitter generates ultraviolet or infrared radiation.

11. An assembly according to any of the preceding claims, wherein the radiation generated by each emitter has substantially the same, single wavelength.

12. A sheet monitoring assembly comprising a transport system for transporting sheets along a transport path; and a sheet detecting assembly according to any of the preceding claims.

13. An assembly according to claim 12, wherein the detector system or detectors detects radiation which has passed through a sheet.

14. An assembly according to claim 12 or claim 13, wherein the transport system includes at least one roller for conveying sheets along the transport path, said at least one first emitter being arranged to illuminate, or said at least one first detector being arranged to detect radiation from, a region of the transport path adjacent the roller.

15. An assembly according to claim 14, wherein the roller is adapted to detect the passage of more than one sheet simultaneously along the transport path.

16. A method of determining the location of an edge of a sheet, the method comprising exposing the sheet to a linear array of radiation beams from respective sources; determining an approximate location of an edge of the sheet extending generally in a direction transverse to the linear array of radiation beams by determining which radiation beam is the first in the array to be at least partially intercepted by the sheet; using the detected intensity of said radiation beam to obtain from a look-up table an offset value corresponding to an amount by which the sheet partially overlaps said radiation beam; and modifying the previously determined approximate location by said offset value, characterized in that the look-up table stores values defining a curve relating the offset values with corresponding intensities, the or each curve being in the form of a multi-piecewise linear function.

17. A method according to claim 16, wherein the sheet is transported past the linear array of radiation beams to which it is regularly exposed.

18. A method according to claim 16 or claim 17, wherein the look-up table stores one curve per radiation source.

19. A method according to any of claims 16 to 18, wherein the or each curve is in the form of a 3-piecewise linear function.

20. A method according to any of claims 16 to 19, further comprising repeating the method to determine the location of an opposite edge of the sheet and thereby determining a lateral dimension between the located edges.

21. A method according to claim 20, wherein the lateral dimension is determined by determining the distance between intercepts, on an x-axis parallel with the linear array of radiation beams, of lines parallel with the located edges and passing through the determined locations of the edges.

22. A method according to claim 20 or 21, further comprising modifying the lateral dimension to take account of the skew of the sheet relative to the linear array of radiation beams.

23. Apparatus for determining the location of an edge of a sheet, the apparatus comprising a set of sources for generating a linear array of radiation beams; one or more radiation beam detectors; and a processor for carrying out a method according to any of claims 16 to 22.
